(19) United States
(12) Patent Application Publication
(10) Pub. No.: US 2005/0097531 A1
(43) Pub. Date: May 5, 2005

(54) Method of compiling a source code program into a machine-readable target object program in a network environment

(76) Inventors: Jorg Fischer, Wilsdruff (DE); Matthias Weiss, Dresden (DE); Paul Schwann, Dresden (DE); Jorg Unbehaun, Dresden (DE)

Correspondence Address: AARON WAXLER;Philips Electronics, 345 Scarborough Road, P.O. Box 3001, Briarcliff Manor, NY, 10510, US

(21) Appl. No.: 10/947,978

(22) Filed: Sep. 23, 2004

(30) Foreign Application Priority Data
Sep. 26, 2003 (DE) 103 44 847.0

(51) Int. Cl. G06F 9/45

(52) U.S. Cl. 717/140

(57) ABSTRACT

In order to minimize the time taken to compile a source code program into a machine-readable target object program in a network environment when the processor is also further developed at the same time as the program is being created, a method is proposed in which the compiler program continuously scans an input interface of the server (10) for a source code program newly written thereto, and a client program is started on a client (20-50), wherein the running of said program causes a source code program that is to be compiled to be written to the input interface of the server and causes an output interface of the server to be continuously scanned for a target object program newly written thereto. In response to the detection of a source code program newly written to the input interface of the server, the source code program is read and compiled into a target object program, which is subsequently written to the output interface of the server. In response to the detection of the target object program written to the output interface of the server, said target object program is read and stored on the client.

The invention relates to a method of compiling a source code program into a machine-readable target object program in a network environment and also to a corresponding computer system for carrying out the method.

In the design of current processors, particularly signal processors, very recently use has been made of development environments in which at least partially specific resources are produced in a computer-assisted manner for the use of the processor, such as for example a hardware specification or even specific software tools. By way of example, international patent application WO 00/46704 describes such a development system in which the compiler for the respective processor is produced automatically from the architectural language specification of the set of instructions. It is not unusual for programs to be written for the processor in a very high-level language even during the development or expansion of said processor. These programs in very high-level language program code are translated by the compiler into an assembler language or into a machine language. If a programmer would like to have his generated source code translated into a machine code by the compiler, it must be ensured that the updated compiler is used, which reflects the current state of processor development. For this reason, prior to the compiling operation, the compiler program must be newly generated or updated on the basis of the current data, for example the architectural language specification of the current set of instructions. This also applies in particular in respect of relatively large programming projects, in which a number of programmers are creating or processing parts of an individual program project at the same time. The generation or configuration phase of the compiler, which is required prior to the actual compiling, is associated with a high time outlay.

It is thus an object of the invention to minimize the time taken to compile a source code program into a machine-readable target object program when the processor is also further developed at the same time as the program is being created.

The invention achieves this object by means of a method of compiling a source code program into a machine-readable target object program in a network environment, said method having the features of claim 1, and by means of a computer system designed to carry out the method, said computer system having the features of claim 12.

The method according to the invention in a network environment which comprises at least one server and a number of user-controlled clients networked to said server is characterized in that a compiler program is started on the server, wherein the compiler program continuously scans an input interface of the server for a source code program newly written thereto, and a client program is started on a client, wherein the running of said program causes a source code program that is to be compiled to be written to the input interface of the server and causes an output interface of the server to be continuously scanned for a target object program newly written thereto. In response to the detection of a source code program newly written to the input interface of the server, the source code program is read and compiled into a target object program, which is subsequently written to the output interface of the server. In response to the detection of the target object program written to the output interface of the server, said target object program is read and stored on the client.

By virtue of the described method, all the clients in the network on which programs have been generated in a very high-level language can access the compiler function of the server so that the clients do not require a compiler function. Thus, only a single compiler has to be kept updated, and this can be carried out independently of the clients.

The invention is based on the idea of facilitating the compiling of program codes in a very high-level language into a language close to a machine language, in which the compiler can continuously change, in that the compiler is maintained centrally and the clients are connected to the server providing the compiler only via a data interface and the respective interfaces are continuously scanned for information, that is to say on the idea of exchanging the source code program in the very high-level language for the target object program in a language close to a machine language. Updating of the compiler is thereby simplified since said compiler can be updated only at one point, that is to say on the server. The clients are completely unaffected by this since they communicate with the server only via said interfaces. With the method according to the invention, updating of the compiler program on the server only has the effect that the source code program is received at the input interface of the server in a delayed manner and the target object program is provided at the output interface of the server in a delayed manner. There is no further effect on the clients caused by the described updating of the server or compiler system on the server.

The continuous scanning of the input interface by the server and of the output interface by the client means that the respective interface is regularly scanned for new data, wherein in some circumstances there may also be a pause between these scanning operations. In any case, the interface is checked or monitored again and again for updated data.

Further advantageous developments of the invention are specified in the dependent claims.

It may be advantageous to design the input and output interfaces as a combined, single, bidirectional interface of the server, thereby minimizing the hardware complexity for connecting the server to the clients.

The described input and output interfaces of the server may be realized in many ways. These interfaces offer only the programs running independently of one another, that is to say the program on the server and the client program, the possibility of exchanging data with one another. By way of example, both the input interface and the output interface may be provided by a memory which can be accessed by both the server and the clients. In this case, a single storage area may suffice, for example on a non-volatile storage medium, in respect of which the server and the clients have the necessary read and/or write rights. The distinction between the source code program and the target object program may be made by different filenames with which the programs are stored on the storage medium. However, it is also possible to store the source code programs and target object programs in different directories, so that differentiation is thereby possible.

In order to control the compiling operation, it may be provided that the file of the source code program furthermore comprises information about compiler switches and/or information about the creation of the file of the target object program. In this way, for example, the compiler can be informed which name it is to give to the target object file. Moreover, however, information relating to the compiling operation, such as a switch for producing a time-optimized or memory-optimized code, may be added.

Particularly advantageously, the two interfaces, that is to say the input interface and the output interface, may be realized using the TCP/IP communication and address concept. By way of example, a port may represent such a communication end point to which the client program or the server program can connect in order to receive data addressed to the port. In this case, the source code program or an associated file or the target object program or an associated file does not need to be stored on a storage medium but rather can be continuously written as a data stream to the port, from which it can be received by the respective other process, that is to say the client program or the server program. It will be understood that information about compiler switches for compiling the source code and/or information for creating the data stream of the target object program may also be stored in such a data stream of the source program.

In order to transmit information about events of the process of compiling the relevant source code program to the client, it may be provided that, in addition to the target object program data, log data are also transmitted to the output interface, thus greatly simplifying for example a search for errors in the source code program.

The compiler program may be updated automatically for the respective processor type during start-up by reading in a processor model database. In order to make changes in the processor database immediately available to all the clients connected to the server for the compiler process, it may be provided that, once the processor model database has been changed, the compiler program on the server is updated on the basis of the changed processor model data.

In terms of the device, the object is achieved by a computer system comprising one server and a number of clients connected to said server via a network, which computer system is designed to carry out the method according to the invention.

The invention will be further described with reference to examples of embodiments shown in the drawing to which, however, the invention is not restricted.

The FIGURE shows a schematic diagram of a computer system according to the invention for carrying out a method of compiling a source code program into a machine-readable target object program in a network environment.

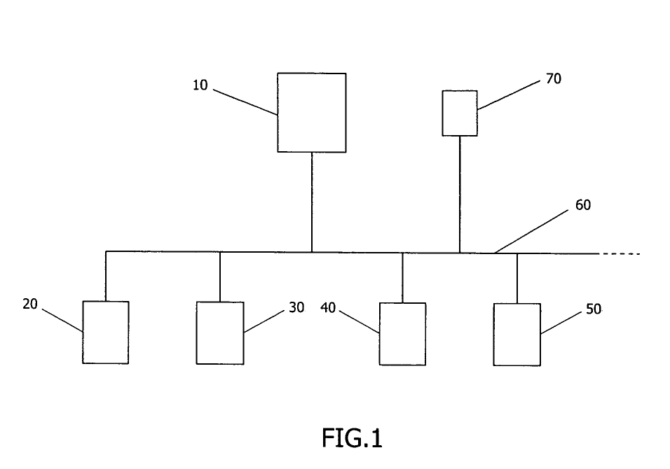

The computer network shown in FIG. 1 comprises a number of autonomous computers which are connected to one another, in this case one server 10 and a large number of clients, only a small number of which are shown by references 20-50. The computers are connected to one another via a data line 60 for the purpose of exchanging information. In the example described, this network is designed as a broadcast LAN with a bus according to the IEEE 802.3 standard.

The computer network shown serves to provide an environment in which to convert source code programs in programming language C, which have been created on the individual clients 20-50, into a machine-readable code. The programs are created for a digital signal processor. In order to provide the compiler function, a compiler program is started on the server 10. As it starts, the server 10 loads a processor model database for the digital signal processor from another server 70 via the network. This ensures that the compiler program is always based on the current design of the digital signal processor which is stored in the processor model database and supports said design. In the present example, the processor model database comprises the complete set of instructions for the digital signal processor. In another embodiment of the invention, the processor model database for the digital signal processor exists directly on the server.

The computers communicate with one another via the TCP/IP protocol. In this protocol, each computer connected to the network is assigned a unique so-called IP address. The server 10 furthermore has two so-called ports via which communication with the clients 20-50 takes place. These ports in each case form, together with the IP address, a so-called socket. The first socket forms the input interface for the server and is used by the clients to transmit data to the server, which continuously monitors the input interface for this purpose. By contrast, the second socket is used as the output interface, to which the server can write data, with the clients 20-50 continuously “listening” at this output interface.

If a C-program has been created on one of the clients and the user would like to have this compiled, said user starts on his computer a client program similar to a script, by means of which the source code program is transmitted to the described input interface of the server along with information about the creation of compiler switches. Since the server continuously monitors the input, it detects the specified information and compiles the C-program on the basis on the required compiler settings. Following the compiling operation, the machine program is output via the output socket, detected by the client and read into the latter, where it is available for further processing on the client. Since, in principle, all clients can access the input socket and the output socket of the server, they must recognize whether the byte stream written at the output socket of the server is also the machine program assigned to them. For this purpose, an identifier is transmitted to the server along with the source code program, said identifier being used by the server when generating the byte stream of the machine program so that each client can clearly detect whether the machine program present at the output interface of the server concerns it.

In another embodiment of the invention, the input and output interfaces of the server are provided by a non-volatile memory. In this case, the clients have a right to write to a specific storage area on a hard disk, to which they write the C-program that is to be compiled. The server continuously monitors this area, detects a newly written file, reads it into its memory and compiles the target object program as described. Thereafter, the generated machine program is written to another area or to the same area of the storage medium, which is continuously monitored by the client for newly written files. Once the newly written machine file has been detected, a check is made to ascertain whether this is assigned to the corresponding client and, if so, it is transmitted to the client computer.

1. A method of compiling a source code program into a machine-readable target object program in a network environment comprising at least one server and a number of user-operable clients data-connected to said server, characterized by the steps:
starting a compiler program on the server (10), the running of which program causes an input interface of the server to be continuously scanned for a source code program newly written thereto;
starting a client program on a client (20-50), the running of which program causes a source code program that is to be compiled to be written to the input interface of the server and causes an output interface of the server to be continuously scanned for a target object program newly written thereto;
reading the source code program and compiling it into a target object program in the server in response to the detection of the source code program newly written to the input interface of the server;
writing the target object program to the output interface of the server (10);
reading from the output interface of the server and storing the target object program on the client in response to the detection of the target object program newly written to the output interface of the server.

2. A method as claimed in claim 1, characterized in that a single interface of the server is used both as input interface and as output interface.

3. A method as claimed in claim 1, characterized in that the source code program and the target object program are in each case written as a file to a predefined directory, respectively assigned thereto, of a non-volatile storage medium of the server, wherein these directories are in each case scanned for newly written files.

4. A method as claimed in claim 3, characterized in that information about compiler switches for compiling the source code program and/or information for creating the file of the target object program is furthermore stored in the file of the source code program.

5. A method as claimed in claim 1, characterized in that the source code program is written continuously as a data stream to a storage area having a predefined storage address of a volatile storage medium of the server (10) and this storage area is continuously scanned for newly written data.

6. A method as claimed in claim 1, characterized in that the target object program is written continuously as a data stream to a storage area having a predefined storage address of a volatile storage medium of the server (10) and this storage area is continuously scanned for newly written data.

7. A method as claimed in claim 5, characterized in that information about compiler switches for compiling the source code program and/or information for creating the data stream of the target object program is furthermore stored in the data stream of the source code program.

8. A method as claimed in claim 1, characterized in that log data are transmitted to the output interface, which log data comprise information about the progress of the compiling of the source code program.

9. A method as claimed in claim 1, characterized in that, when the compiler program is started on the server (10), a processor model database for compiling the source code program for a predefined processor is loaded.

10. A method as claimed in claim 9, characterized in that, once the processor model database has been changed, the compiler program on the server (10) is updated on the basis of the changed processor model data.

11. A method as claimed in claim 1, characterized in that the compiler program running on the server (10) and the client program running on the client (20-40) are executed independently of one another, wherein data are exchanged between the two programs via the output interface and the input interface of the server.

12. A computer system comprising one server (10) and a number of clients
(20-40) connected to said server via a network, for carrying out a method as claimed in claim 1.

13. A storage medium, comprising electronically readable information for controlling a programmable computer, in particular a server and/or a client, such that a method as claimed in claim 1 is carried out during the processing of the information on the computer.
